(19) United States
(12) Patent Application Publication
(10) Pub. No.: US 2026/0157915 A1
(43) Pub. Date: Jun. 11, 2026

(54) KNEE JOINT AUXILIARY DEVICE AND MECHANISM HAVING POWER SOURCE ASSEMBLY

(71) Applicant: NATIONAL YANG MING CHIAO TUNG UNIVERSITY, HSINCHU (TW)

(72) Inventors: Kit-Ieng CHEANG, HSINCHU (TW); Bing-Shiang YANG, HSINCHU (TW)

(73) Assignee: NATIONAL YANG MING CHIAO TUNG UNIVERSITY, HSINCHU (TW)

(21) Appl. No.: 19/180,613

(22) Filed: Apr. 16, 2025

(30) Foreign Application Priority Data
Jul. 1, 2024 (TW) 113124597

(51) Int. Cl. A61H 3/00; A61H 1/02

(52) U.S. Cl. CPC A61H 3/00; A61H 1/024; A61H 2201/0192

(57) ABSTRACT

A device having a power source assembly is provided, and the device comprises a first support, a second support, a power delivering structure, and a link. The power delivering structure has a first end, a mounted part, and a power body disposed between the first end and the mounted part mounted in the second support. The power source assembly has a second end, a side part, and an actuated part, wherein the side part is mounted on the first support, and the actuated part is to be actuated by the power body. The link has a third end and a fourth end opposed to each other, wherein the third end is combined with the second end, and the first end is rotatably disposed on the fourth end.

### CROSS REFERENCE TO RELATED APPLICATIONS

The application claims the benefit of Taiwan Patent Application No. 113124597, filed on Jul. 1, 2024, at the Taiwan Intellectual Property Office, the disclosures of which are incorporated herein in their entirety by reference.

### FIELD OF THE INVENTION

The present invention generally relates to a knee joint auxiliary device and mechanism and, more particularly, to a knee joint auxiliary device and mechanism having a power source assembly.

### BACKGROUND OF THE INVENTION

The conventional wearable knee joint auxiliary devices can be used to assist the user in walking on flat surfaces or stepping up or down stairs. Some wearable knee joint auxiliary devices are designed to have the torsion spring as the power source.

In this design, if the state of the shank is changed from the upright state to the flexion state in the action of stepping up or down stairs or walking, the flexion of the knee joint will be subject to excessive resistance force from the power source, and thus the user will need more muscle force to resist the resistance force during the action.

### SUMMARY OF THE INVENTION

In one aspect, the present invention provides a knee joint auxiliary device DE, the knee joint auxiliary device DE comprising a power source PO, a first support member SP1, a second support member SP2, a first link LI1, a second link LI2, and a second power transmission component PW, wherein the power source PO has a first power transmission component POA and a fulcrum POB, the first support member SP1 has a first end SP1B, the first link LI1 has a first side part LI1A, a second side part LI1B, and a second end PN1A, the second link LI2 has a third end LI2A and a fourth end LI2B, and the second power transmission part PW has an installation part PN2C, a fifth end PN2A, and a power body PWC disposed between the installation part PN2C and the fifth end PN2A. The second side part LI1B is installed on the first end SP1B, the power source PO is installed on the first side part LI1A, the installation part PN2C is installed into the second support member SP2, the fifth end PN2A is disposed on the fourth end LI2B of the second link LI2, and the third end LI2A is hinged with the second end PN1A, so as to enable the second support member SP2 to rotate relative to the second end PN1A by means of the second link LI2. Therefore, the second support rod member SP2 is rotatable by means of the second link LI2 by a first angle relative to the second end PN1A to cause the power body PWC to actuate the first power transmission component POA, so as to cause the first power transmission component POA to rotate by a second angle relative to the fulcrum POB to store a power in the power source PO, wherein the first angle is greater than the second angle.

In another aspect, the present invention provides a power providing mechanism ppa having a power source assembly pos, the power providing mechanism ppa comprising a first support member sp1, a second support member sp2, a power transmission structure pwg, and a link li2. The power transmission structure pwg has a first end pn2a and an installation part pn2c which is installed into the second support member sp2. The power source assembly pos has a second end posa and a side part li1b, wherein the side part li1b is installed on the first support member sp1. The link li2 has a third end li2a and a fourth end li2b opposite to each other, and the third end li2a is combined with the second end posa, wherein the first end pn2a is rotatably disposed on the fourth end li2b.

### BRIEF DESCRIPTION OF THE DRAWINGS

The above embodiments and advantages of the present invention will become more readily apparent to those ordinarily skilled in the art after reviewing the following detailed descriptions and accompanying drawings.

FIG. 1A-1 illustrates the lower limb L that can wear the knee joint auxiliary device DE according to an embodiment of the present invention.

FIG. 1A-2 illustrates the knee joint auxiliary device DE according to an embodiment of the present invention.

FIG. 1B-1 illustrates the thigh support TS of the knee joint auxiliary device DE of FIG. 1A-2 according to an embodiment of the present invention.

FIG. 1B-2 illustrates the shank support SS of the knee joint auxiliary device DE of FIG. 1A-2 according to an embodiment of the present invention.

FIGS. 1C-1 and 1C-2 illustrate a detailed structure of the power providing mechanism PP according to an embodiment of the present invention.

FIGS. 2A and 2B are schematic diagrams of the angle changes of the support member SP2 and the angle changes of the actuated part POC during the period where the shank part is in the condition from the upright state to the transition state, and the condition from the transition state to the flexion state when the user wearing the knee joint auxiliary device DE according to an embodiment of the present invention is stepping up or down stairs or walking on flat surfaces.

FIGS. 2C and 2D are schematic diagrams of the angle changes of the support member SP2 and the angle changes of the actuated part POC during the period where the shank part is in the condition from the flexion state to the transition state, and the condition from the transition state to the upright state when the user wearing the knee joint auxiliary device DE according to an embodiment of the present invention is stepping up or down stairs or walking.

FIG. 3 illustrates a conventional knee joint auxiliary device.

FIG. 4A illustrates the relationship between the rotation angle (θ1) of the support member CKA and the moment T (θ2) applied to the actuated part CKC according to the Equation (1).

FIG. 4B illustrates the relationship between the rotation angle (θ1) of the support member SP2 and the moment T (θ2) applied to the actuated part POC according to the Equation (1).

FIG. 5 illustrates a knee joint auxiliary device DE according to an embodiment of the present invention in a positioning state.

FIG. 6 illustrates a power providing mechanism ppa for a knee joint auxiliary device according to an embodiment of the present invention.

### DETAILED DESCRIPTION OF THE PREFERRED EMBODIMENTS

Please refer to all figures of the present invention when reading the following detailed description, wherein all figures of the present invention demonstrate different embodiments of the present invention by showing examples, and help the skilled person in the art to understand how to implement the present invention. The present examples provide sufficient embodiments to demonstrate the spirit of the present invention, each embodiment does not conflict with the others, and new embodiments can be implemented through an arbitrary combination thereof, i.e., the present invention is not restricted to the embodiments disclosed in the present specification. Unless there are other restrictions defined in the specific example, the following definitions apply to the terms used throughout the specification.

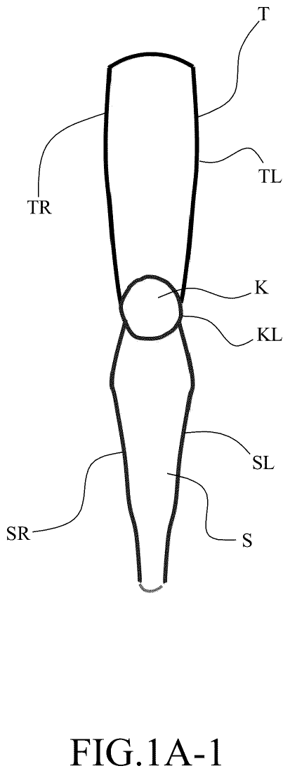

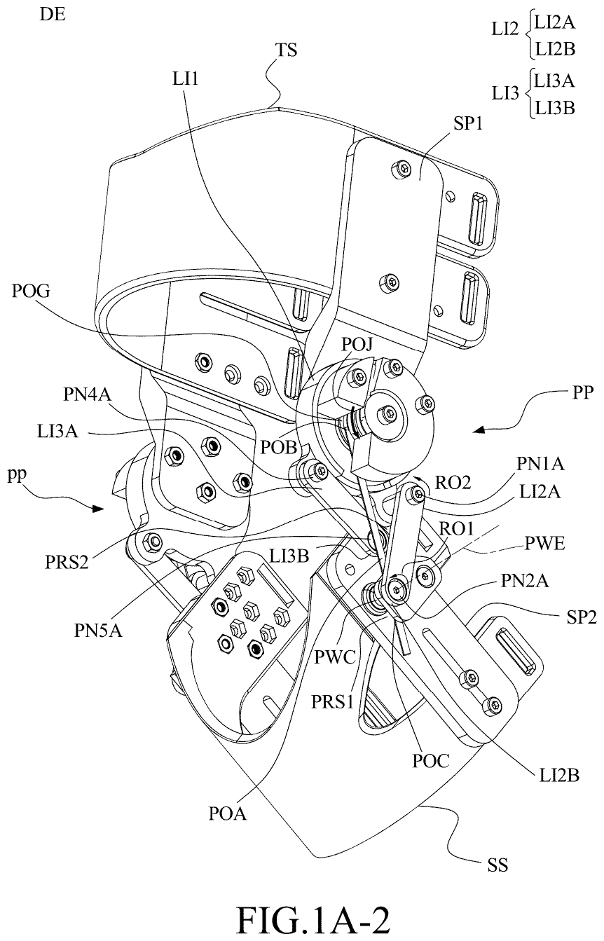

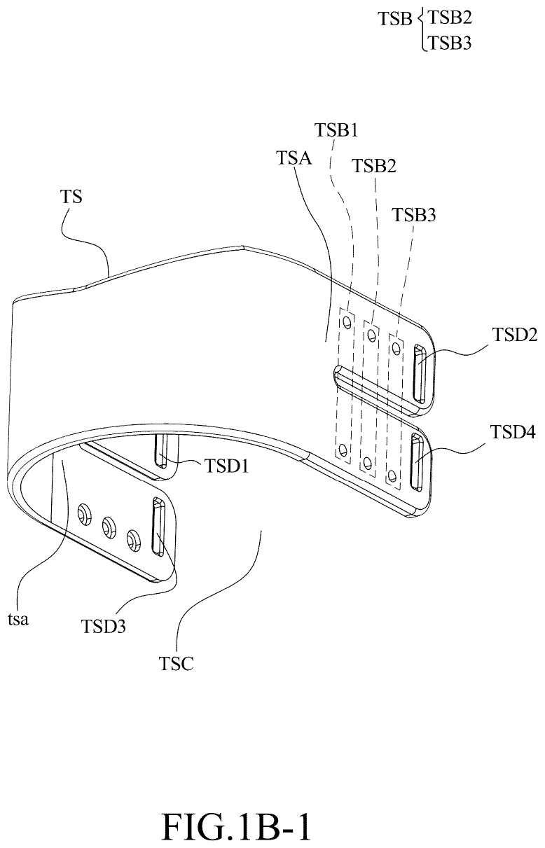

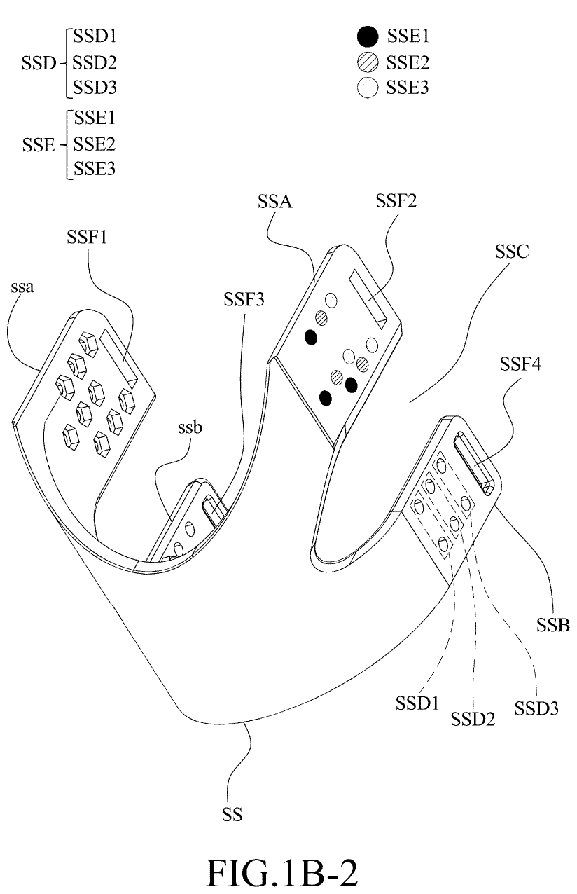

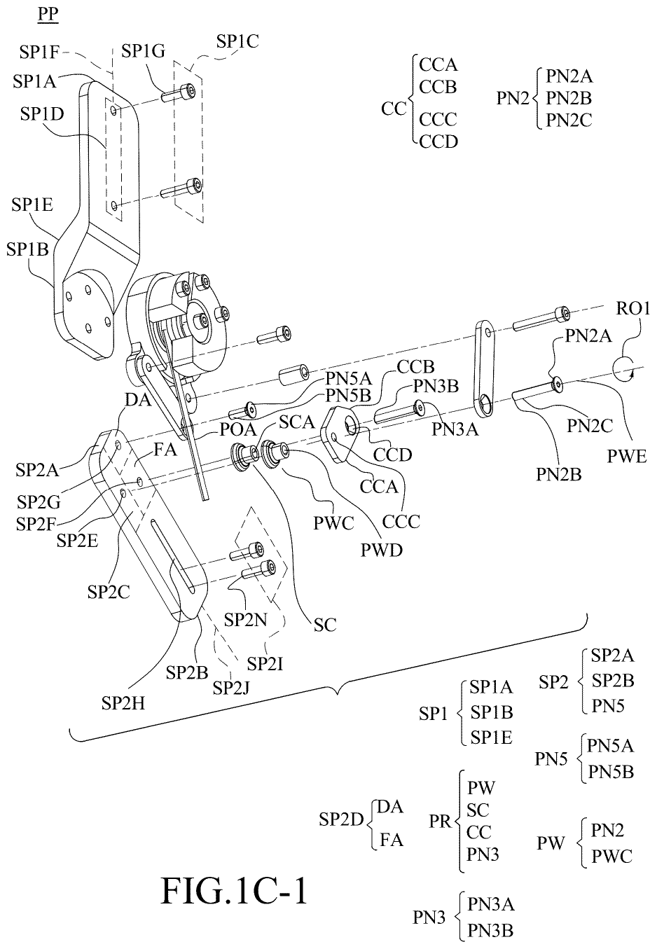

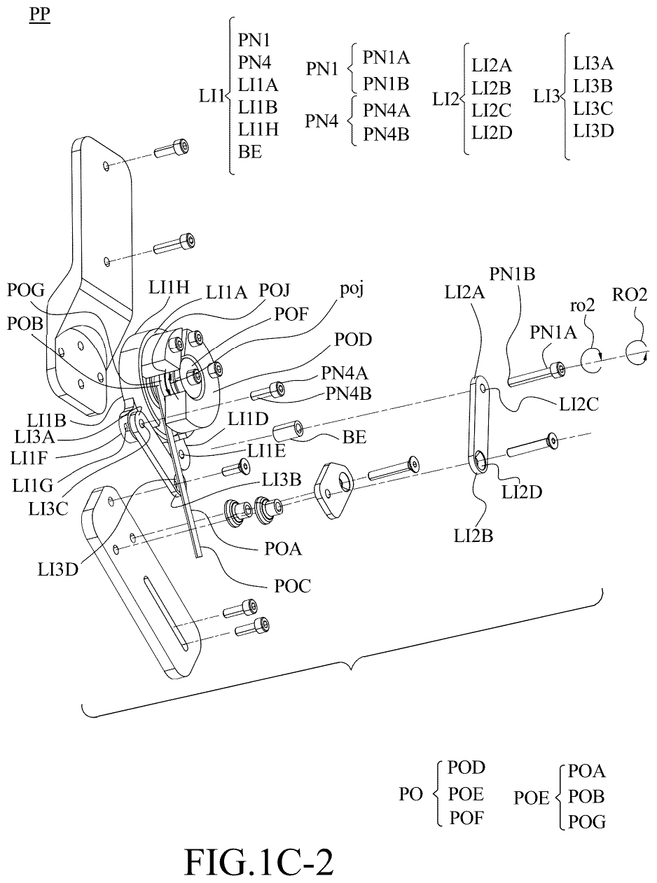

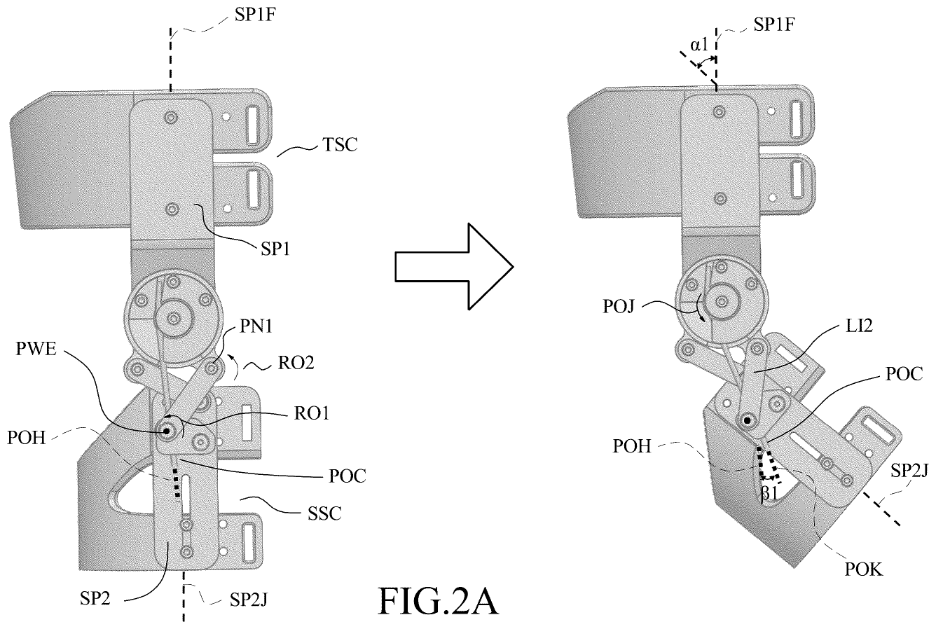

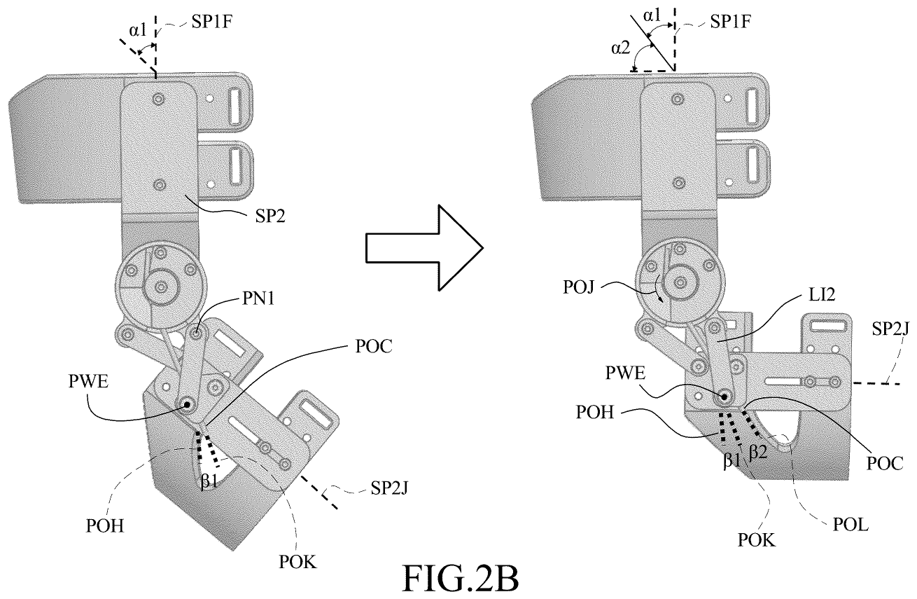

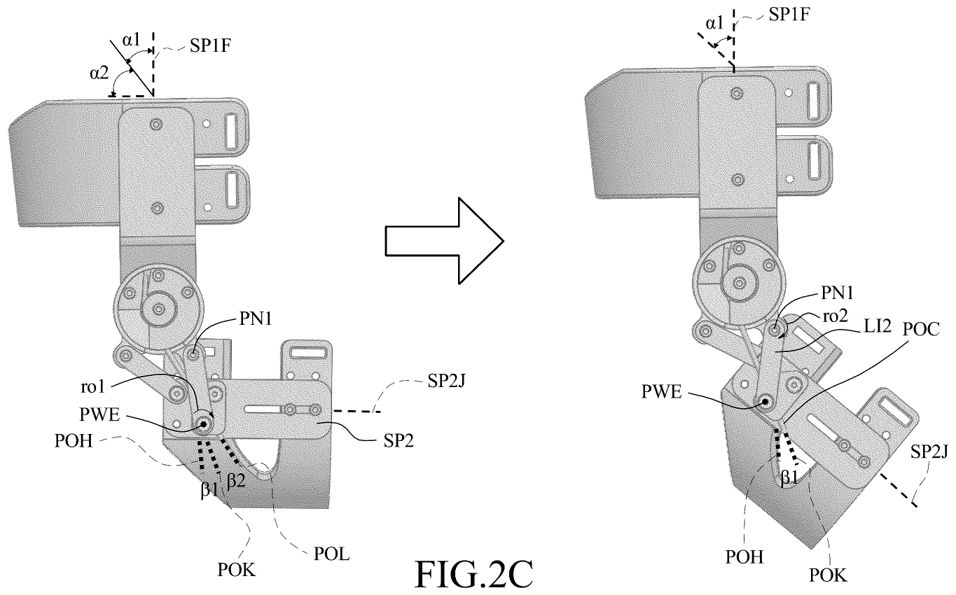

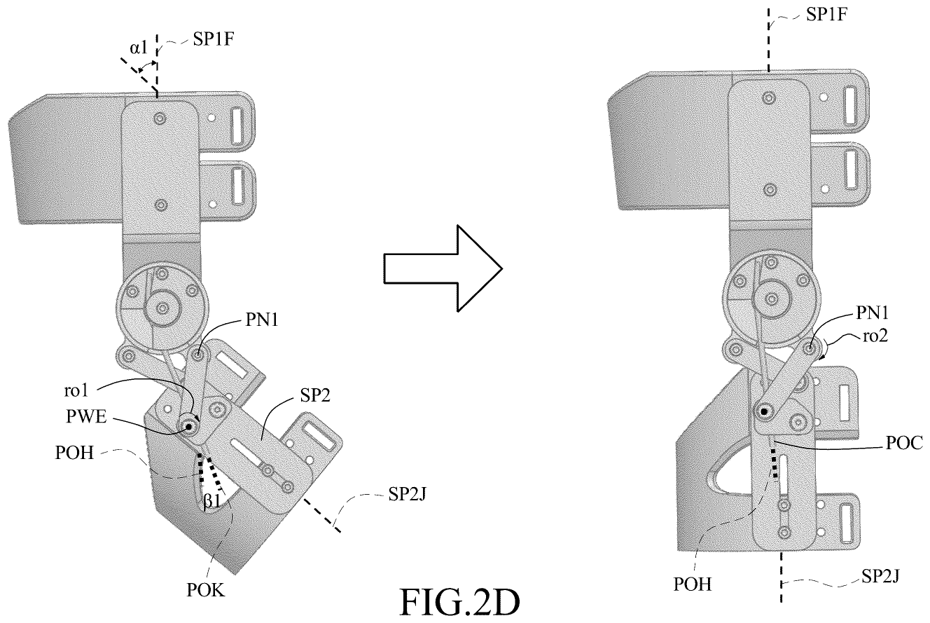

The relevant technical features below of the present invention are described with reference to FIGS. 1A-1 and 1A-2, wherein FIG. 1A-1 illustrates a lower limb L (e.g., a left leg or a right leg) wearing the knee joint auxiliary device DE shown in FIG. 1A-2, and FIG. 1A-2 illustrates the knee joint auxiliary device DE according to an embodiment of the present invention. In detail, the lower limb L has a thigh part T, a shank part S, and a knee part K therebetween, wherein the thigh part T has a first thigh side TL and a second thigh side TR opposite to the first thigh side TL, the shank part S has a first shank side SL and a second shank side SR opposite to the first shank side SL, the knee part K has a first knee part side KL between the first thigh side TL and the first shank side SL, and a second knee part side KR opposite to the first knee part side KL and between the second thigh side TR and the second shank side SR. The knee joint auxiliary device DE is configured to be worn on the lower limb L of the user to assist the shank part S of the lower limb L of the user to undergo a process from an upright state to a transitional state, from the transitional state to a flexion state, from the flexion state to the transition state, and from the transition state to the upright state while stepping up or down stairs or walking on flat surfaces.

The knee joint auxiliary device DE includes power providing mechanisms PP and pp (further descriptions of the power providing mechanism pp is provided in Paragraph [0063] and related paragraphs thereafter), a thigh support TS, and a shank support SS. The power providing mechanism PP has a support member SP1, a support member SP2, a link LI1, a link LI2, a link LI3, a spring body POG with a spring coefficient, an end PN2A, a power body PWC, a protection space PRS1, and a accommodation space PRS2.

The support member SP2 has an end PN5A, the link LI1 has an end PN1A and an end PN4A, the link LI2 has an end LI2A and an end LI2B opposite to each other, and the link LI3 has an end LI3A and an end LI3B opposite to each other. The spring body POG has a fulcrum POB and a power transmission component POA connected to the fulcrum POB, the power transmission component has an actuated part POC, and the power body PWC has a center axis PWE passing through the end PN2A. Further, the link LI1 is installed between the spring body POG and the support member SP1, the installation pin (not shown in FIGS. 1A-2) having the end PN2A passes through the end LI2B, the power body PWC, and the support member bar SP2 so that the end PN2A can be rotatably located on the end LI2B, and the end LI2A is hinged with the end PN1A. The end LI3A and the end LI3B of the link LI3 are hinged with the end PN4A and the end PN5A, respectively, so that the link LI3 is rotatable relative to the end PN4A and the end PN5A.

Therefore, in the process of stepping up or down stairs or walking, since the end LI2A is hinged with the end PN1A and the end PN2A is rotatably disposed on the end LI2B, the support member SP2 can be rotated in the rotation direction RO1 by means of the end PN2A relative to the center axis PWE, and the power body PWC can be rotated in the rotation direction RO2 along with the support member SP2 by means of the link LI2 relative to the end PN1A. Therefore, the power body PWC can actuate the actuated part POC to apply a torque to the power transmission component POA to rotate the power transmission component POA in the rotation direction POJ with respect to the fulcrum POB in order to store power in the spring body POG. The strength of the material of the power transmission component POA is such that the power transmission component POA rotates relative to the fulcrum POB without visible bending, so that the power that is desired can be stored.

Furthermore, because the spring body POG has the spring coefficient, when the power body PWC applies a moment T(θ) to the actuated part POC to rotate the power transmission component POA by an angle θ, then θ and T(θ) satisfy the following equation (1).

$$T ( θ ) = κθ \qquad ( 1 )$$

In addition, in the process of stepping up or down the stairs or walking, because the power transmission component POA rotates only relative to the fulcrum POB, but the support member SP2 can rotate not only with respect to the center axis PWE of the power body PWC, but also with respect to the end PN1A, the power transmission component POA will rotate by the specific angle less than the total rotation angle by which the support member SP2 rotates.

Furthermore, the actuated part POC is configured in the protection space PRS1 so that the actuated part POC is protected from being affected by or interfered with by undesired external factors, and the end LI3B of the link LI3 is disposed in the accommodation space PRS2 so that the longitudinal axis of the link LI3 can be configured to cross the longitudinal axis of the link LI2. In the implementation and simulation of the link motions, the inventor found that in this cross configuration, the link LI3 can rotate relative to the end PN4A and the end PN5A without hindering the rotation of the support member SP2 relative to the end PN1A along the center axis PWE. Thus, the stability of the connection between the link LI1 and the support member SP2 can be maintained and improved for controlling the support member SP2 and the power transmission component POA to rotate by means of the link LI3 and the link LI2.

The further technical features of the present invention are described as follows with reference to FIGS. 1A-2, 1B-1, and 1B-2. FIGS. 1B-1 and 1B-2 illustrate the thigh support TS and the shank support SS of the knee joint auxiliary device DE of FIGS. 1A-2, respectively. In detail, the thigh support TS has a thigh support side TSA, a thigh support side tsa relative to the thigh support side TSA, a first pair of the strap hole TSD1 and strap hole TSD2, a second pair of the strap hole TSD3 and strap hole TSD4, and a receiving part TSC. The thigh support side TSA has a set of thigh adjustment parts TSB having the thigh adjustment part TSB1, the thigh adjustment part TSB2, and the thigh adjustment part TSB3.

Depending on the actual requirements, the set of thigh adjustment parts TSB may be configured to have more or fewer thigh adjustment parts. The thigh support side TSA and the thigh support side TSA are configured to form the receiving part TSC, which is configured to receive the thigh part T of the lower limb L. A user can secure the thigh support TS to the thigh part T by using a thigh wrap (not shown) that passes through the first pair of the wrap holes TSD1 and TSD2 and another thigh wrap (not shown) that passes through the second pair of wrap holes TSD3 and TSD4.

The shank support SS has a receiving part SSC, a shank support sides SSA and SSB mutually adjacent to each other, a third pair of wrap holes SSF1 and SSF2, a fourth pair of wrap holes SSF3 and SSF4, and shank support sides ssa and ssb mutually adjacent to each other and opposite to the shank support sides SSA and SSB, respectively. The shank support side SSA and the shank support side SSB have a set of near-knee adjustment parts SSE and a set of shank adjustment parts SSD, respectively. The set of near-knee adjustment parts SSE has near-knee adjustment parts SSE1 to SSE3, and the set of shank adjustment parts SSD has shank adjustment parts SSD1 to SSD3. Depending on actual requirements, the set of near-knee adjustment parts SSE can be configured to have more or fewer near-knee adjustment parts, and the set of shank adjustment parts SSD can be configured to have more or fewer shank adjustment parts. In addition, the shank support sides SSA, SSB, ssa and ssb are configured to form the receiving part SSC, and the receiving part SSC is configured to receive the shank part S of the lower limb L. The user can secure the shank support SS to the shank part S using the shank wrap (not shown) passing through the third pair of wrap holes SSF1 and SSF2 and a shank wrap (not shown) passing through the fourth pair of wrap holes SSF3 and SSF4. The materials of the thigh support TS and the shank support SS can be made of thermoplastic plastic that can be thermoplastic polyurethane (TPU) to provide elasticity and flexibility while the user is wearing the device DE. Additionally, each of the thigh support TS and the shank support SS can be provided with a soft or flexible padding on a side adjacent to the lower limb to provide comfort to the user when wearing the knee auxiliary device DE.

Details of the aforementioned power providing mechanism PP are described below based on FIGS. 1A-2, 1C-1, and 1C-2. The power providing mechanism PP has a support member SP1, a support member SP2, a link LI1, a link LI2, a link LI3, a protection structure PR, a protection space PRS1, a accommodation space PRS2, and a power source PO. The support member SP1 has an end SP1B, an end SP1A, and a connection block SP1E between the end SP1B and the end SP1A, the end SP1A has a set of thigh adjustment elements SP1C and a set of thigh installation holes SP1D, and each thigh adjustment element of the set of thigh adjustment elements SP1C has a thigh adjustment element end SP1G.

The support member SP2 has an end SP2A, an end SP2B, and a hinge pin PN5. The end SP2B has a set of shank adjustment elements SP2I and a shank installation hole SP2H, and each shank adjustment element of the set of shank adjustment elements SP2I has a shank adjustment element end SP2N. The end SP2A includes block areas SP2C and SP2D mutually adjacent to each other, the block area SP2D includes area sections DA and FA, the block area SP2C includes the hole SP2E, and the area section DA and the area section FA include the holes SP2F and SP2G, respectively. The hinge pin PN5 has ends PN5A and PN5B opposite to each other.

The link LI1 has a hinge pin PN1, a hinge pin PN4, a bearing BE, a side part LI1A, a side part LI1B, and a link body LI1H between the side parts LI1A and LI1B, wherein the link body LI1H has an end LI1D, an end LI1F, and a slit LI1J provided between the end LID and the end LI1F. The ends LI1D and LI1F have the holes LI1E and LI1G (the hole LI1G is shown in dashed lines, to denote where it is hidden from view in FIG. 1C-2), respectively. The hinge pin PN1 has ends PN1A and PN1B opposite to each other, and the hinge pin PN4 has ends PN4A and PN4B opposite to each other.

The link LI2 has ends LI2A and LI2B, and the ends LI2A and LI2B have holes LI2C and LI2D, respectively.

The power source PO has a receiving part POD, a torsion spring POE, and a baffle POF, wherein the torsion spring POE has a spring body POG, a fulcrum POB, and a power transmission component POA which is connected to the fulcrum POB and has an actuated part POC.

The link LI3 has ends LI3A and LI3B opposite to each other, and the ends LI3A and LI3B comprise the holes LI3C and LI3D, respectively.

The protection structure PR has a power transmission component PW, a support member SC, a connection component CC, and an installation pin PN3. The power transmission component PW has an installation pin PN2 and a power body PWC, wherein the power body PWC has a hole PWD and a central axis PWE passing through the hole PWD, the installation pin PN2 has an end PN2A, an end PN2B, and an installation part PN2C arranged between the end PN2A and the end PN2B, and the installation pin PN3 has ends PN3A and PN3B opposite to each other. The support part SC has a hole SCA, and the connection component CC has ends CCA and CCB opposite to each other, wherein the ends CCA and CCB have holes CCC and CCD, respectively.

In addition, the end PN3B of the installation pin PN3 is configured to pass through the hole CCD of the end CCB, the hole SC of the support part SC, and the hole SP2F of the area section FA in sequence to dispose the end PN3A on the end CCB, so as to combine the end CCB, the support part SC, and the area section FA together.

In addition, the hole PWD of the power transmission component PW is aligned with the hole SP2E of the block area SP2C of the support member SP2, so that the end PN2B of the installation pin PN2 can pass through the hole LI2D, the hole CCC of the connection component CC, the hole PWD of the power transmission component PW, and the hole SP2E of the block area SP2C of the support member SP2 in sequence along the central axis PWE of the hole PWD. Accordingly, the end PN2A is rotatably disposed on the end LI2B and the installation part PN2C is disposed in the hole SP2E to allow the end LI2B, the end CCA, the power body PWC, and the block area SP2C to be combined together, and therefore, the support member SP2 is rotatable in the rotation direction RO1 by means of the installation pin PN2 of the power transmitting component PW with respect to the central axis PWE of the power body PWC.

In addition, the end PN1B of the hinge pin PN1 is configured to pass through the aperture LI2C, the bearing BE arranged between the end LI1D and the end LI2A, and the hole LI1E in sequence, so that the end PN1A is hinged with the end LI2A, and the end LI2A, the bearing BE, and the end LI1D are combined together. Since the end PN1A is hinged with the end LI2A, the support member SP2 can be rotated in the rotation direction RO2 with respect to the hinge pin PN1 by means of the link LI2, and thus the power transmission component PW can be similarly rotated in the rotation direction of RO2 along with the support member SP2 by means of the link LI2 with respect to the hinge pin PN1.

Therefore, since the support member SP2 is rotatable in the rotation direction RO2 with respect to the hinge pin PN1 by means of the link LI2, and the support member SP2 is rotatable in the rotation direction RO1 with respect to the central axis PWE of the power body PWC, the support member SP2 can be rotatable with respect to the hinge pin PN1 when rotating with respect to the central axis PWE (in other words, the support member SP2 can be rotatable with respect to the central axis PWE when rotating with respect to the hinge pin PN1).

In addition, the combination of the end CCB, the support part SC, and the area section FA, and the combination of the end LI2B, the end CCA, the power transmission component PW, and the block area SP2C forms the protection space PRS1, and the combination of the end LI2A, the bearing BE, and the end LI1D, and the combination of the end LI2B, the end CCA, the power transmission component PW, and the block area SP2C form the accommodation space PRS2.

Further, the end LI3B of the link LI3 is disposed in the accommodation space PRS2 such that the longitudinal axis of the link LI3 can be configured to cross the longitudinal axis of the link LI2, wherein the end PN4B of the hinge pin PN4 is configured to pass through the hole LI3C of the link LI3 and the hole LI1G of the link LI1 in sequence such that the end PN4A is hinged with the end LI3A and the end LI3A is combined with the end portion LI1F. The end PN5B of the hinge pin PN5 passes through the hole LI3D and the hole SP2G of the area section DA in sequence so that the end PN5A is hinged with the end LI3B, and the end LI3B is combined with the area section DA.

Further, the side part LI1B of the link LI1 is provided at the end SP1B of the support member SP1 to assemble the link LI1 with the support member SP1. In addition, the receiving part POD is configured to receive the spring body POG of the torsion spring POE and is installed on the side part LI1A, and the baffle POF is combined with the receiving part POD to prevent the spring body POG from falling out of the receiving part POD. The power transmission component POA has an appropriate length, and the appropriate length is such that the actuated part POC can be provided in the protection space PRS1 to be protected from being interfered with by unnecessary external factors.

In addition, the power body PWC is configured to apply a biasing moment to the actuated part POC when the central line SP1F of the support member SP1 and the central line SP2J of the support member SP2 are parallel to each other (thus, a corresponding moment for balancing is generated at the fulcrum POB). Therefore, during the period from the upright state to the transition state, the period from the transition state to the flexion state, the period from the flexion state to the transition state, and the period from the transition state to the upright state as described in Paragraphs [0048], [0053], [0055] and [0058] below, the actuated part POC and the power body PWC are in contact with each other. Since the power body PWC and the actuated part POC are in contact with each other, at any time when the power body PWC is rotating in the rotation direction RO2 along with this support member SP2 by means of the link LI2 with respect to the hinge pin PN1, the power body PWC can actuate this actuated part POC of this power transmission component POA. Therefore, the power transmission component POA can be caused to rotate in the slit LI1J with respect to the fulcrum POB in order to store power in the spring body POG of the power source PO.

On the contrary, when the power body PWC is rotated along with the support member SP2 in the rotation direction ro2 opposite to the rotation direction RO2 by means of the link LI2 with respect to the hinge pin PN1, the power body PWC in contact with the power transmission component POA does not actuate the actuated part POC. As a result, the power stored in the spring body POG is released to cause the actuated part POC to rotate in the rotation direction poj (opposite to the rotation direction POJ) with respect to the fulcrum POB, and thus the actuated part POC applies a pushing force to the power body PWC for assisting the support member SP2 in rotating in the rotation direction ro2.

In addition, the power body PWC and the power transmission component POA are in contact with each other during the period from the upright state to the transition state, the period from the transition state to the flexion state, the period from the flexion state to the transition state, and the period from the transition state to the upright state. As a result, the power body PWC and the power transmission component POA are not separated from each other, and the situation where the power body PWC is not capable of actuating the actuated portion POC or the situation where the actuated portion POC is not capable of applying a pushing force to the power body PWC can be avoided.

FIGS. 1A-2 and FIG. 2A illustrate the angle change from 0 degrees to α1 (i.e., the angle change of the knee) between the central line SP1F and the central line SP2J and the angle change of the actuated part POC during the period from the upright state to the transition state of the shank part of a user wearing the knee joint auxiliary device DE while stepping up or down stairs or walking.

First, since the knee of the user has a rotation limit angle (here assumed to be α1+α2 as shown in FIG. 2B), it is known that α1 will be smaller than the rotation limit angle. Therefore, when walking or stepping up or down stairs, the upright state is defined as the condition where the central line SP1F is parallel to the centerline SP2J and thus the angle therebetween is 0 degrees, the transition state is defined as the condition where the angle between the central line SP1F and the central line SP2J is greater than 0 degrees and less than the rotation limit angle, and the flexion state mentioned in Paragraph [0053] is defined as the condition where the angle between the central line SP1F and the central line SP2J is equal to α1+α2 mentioned above.

In addition, when the thigh part received in the receiving part TSC and the shank part received in the receiving part SSC are in the upright state, because the central line SP1F is parallel to the central line SP2J and thus the angle therebetween is 0 degrees, the position of the actuated portion POC is defined as an upright position POH.

Further, in the process where the user walks or steps up or down stairs, when the shank part swings to enter the transition state from the upright state, the support member SP2 rotates not only in the rotation direction RO2 with respect to the hinge pin PN1, but also in the rotation direction RO1 with respect to the central axis PWE. As a result, the support member SP2 rotates by a total angle of α1 degrees (i.e., the angle between the central line SP1F and the central line SP2J is α1<the rotation limit angle).

During the period when the angle between the central line SP1F and the central line SP2J becomes α1 degrees, the power body PWC rotates along with the support member SP2 in the rotation direction RO2 by means of the link LI2 with respect to the hinge pin PN1. Therefore, the power body PWC can actuate the actuated part POC so that the actuated part POC rotates in the rotation direction POJ by an angle of β1 which is smaller than the angle of α1 from the upright position POH to the position POK (in this case, this position POK is defined as the transition position POK) in order to store the power corresponding to the angle of β1 into the spring body POG.

FIGS. 1A-2 and 2B illustrate the angle change from α1 to α1+α2 between the central line SP1F and the central line SP2J and the angle change of the actuated part POC during the period when the shank part enters into the flexion state from the transition state. In detail, when the shank part swings from the transition state into the flexion state, the support member SP2 will rotate with respect to the central axis PWE in the rotation direction RO1 while rotating with respect to the hinge pin PN1, so that the support member SP2 additionally rotates by a total angle of α2, i.e., the angle between the central line SP1F and the central line SP2J becomes α1+α2.

During the period when the angle between the central line SP1F and the central line SP2J is α1+α2, the power body PWC can rotate along with the support member SP2 in the rotation direction RO2 by means of the link LI2 with respect to the hinge pin PN1. The power body PWC can thus actuate the actuated part POC so that the power transmission component POC rotates in the rotation direction POJ by an angle of β2 smaller than the angle of α2 from the transition position POK to the position POL (which in this case is defined as the flexion position POL), in order to store the power corresponding to the angle of β2 into the spring body POG.

FIGS. 1A-2 and 2C illustrate an angle change from α1+α2 to α1 between the central line SP1F and the central line SP2J and an angle change of the actuated part POC during the period when the shank part enters the transition state from the flexion state.

First, when the shank part swings to enter the transition state from the flexion state, the support member SP2 will rotate in the rotation direction ro1 opposite to the rotation direction RO1 with respect to the central axis PWE while rotating with respect to the hinge pin PN1, so that the support member SP2 will rotate by a total angle of α2 (i.e., the angle between the central line SP1F and the central line SP2J will become α1 due to the reduction of α2).

During the period when the angle between the central line SP1F and the central line SP2J decreases by α2 as a result of the rotation of the support member SP2, the power body PWC rotates along with the support member SP2 in the rotation direction ro2 (opposite to the rotation direction RO2) with respect to the hinge pin PN1 by means of the link LI2, so that the power body PWC does not actuate the actuated part POC. As a result, the power stored in the spring body POG corresponding to the angle of β2 is released to cause the actuated part POC to rotate by the angle of β2 which is smaller than the angle of α2 to come to the transition position POK from the flexion position POL, and at the same time, to cause the actuated part POC to apply a pushing force to the power body PWC to assist in the rotation of the support member SP2.

FIGS. 1A-2 and 2D illustrate an angle change from α1 to 0 between the central line SP1F and the central line SP2J and an angle change of the actuated part POC during the period when the shank part enter the upright state from the transition state. In detail, when the shank part swings to enter the upright state from the flexion state, the support member SP2 rotates with respect to the central axis PWE in the rotation direction ro1 while rotating with respect to the hinge pin PN1, so that the support member SP2 rotates by a total angle of α1 (i.e., the angle between the central line SP1F and the central line SP2J decreases by α1 and thus the central line SP1F and the central line SP2J are parallel to each other).

During the period when the angle between the central line SP1F and the central line SP2J decreases by α1, the power body PWC rotates along with the support member SP2 in the rotation direction ro2 with respect to the hinge pin PN1 by means of the link LI2, so that the power body PWC does not actuate the actuated part POC. As a result, the power stored in the spring body POG corresponding to the angle of β1 is released to further cause the actuated part POC to rotate by the angle of β1 which is smaller than the angle of α1 to come to the upright position POH from the transition position POK, and at the same time, to cause the actuated part POC to further generate a pushing force to the power body PWC to assist in the rotation of the support member SP2.

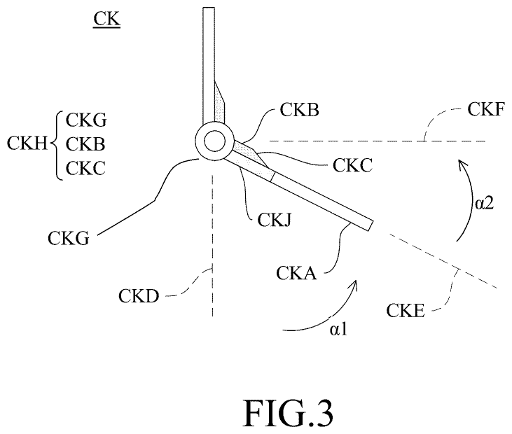

FIG. 3 illustrates a conventional knee joint auxiliary device CK having a torsion spring CKH, a power body CKJ, and a support member CKA, wherein the torsion spring CKH has a spring body CKG with a spring coefficient, and a power transmission component CKB having an actuated part CKC. Specifically, during the period when rotating from the upright position CKD to the transition position CKE, and from the transition position CKE to the flexion position CKF, if the support member CKA rotates by a specific angle, the power body CKJ actuates the actuated part CKC to cause the actuated part CKC to rotate by the same specific angle.

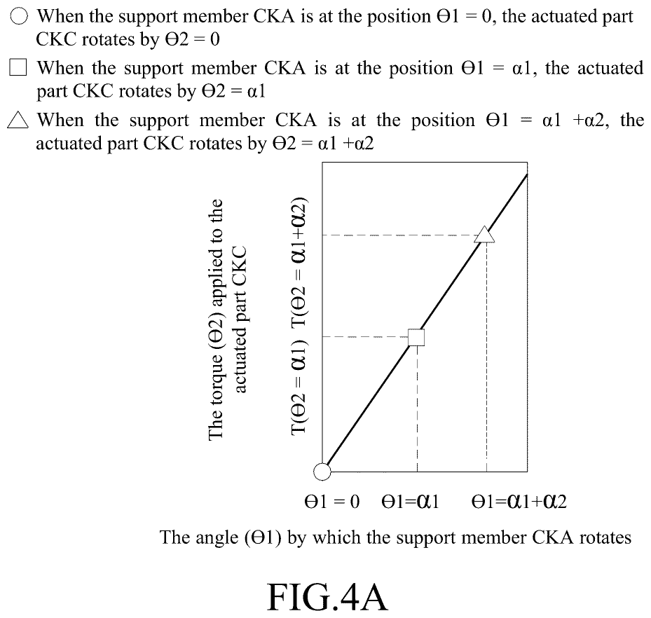

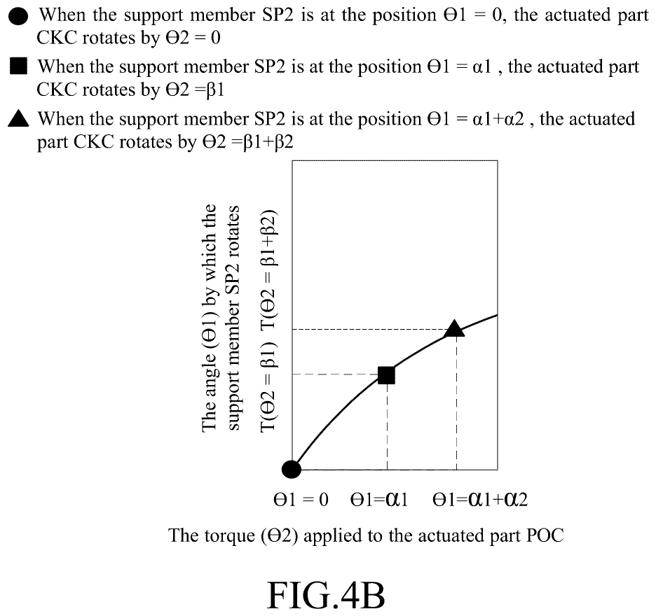

Further, FIGS. 3 and 4A illustrate the relationship between the rotation angle (θ1) of the support member CKA and the torque T (θ2) applied to the actuated part CKC according to the aforementioned equation (1). As shown in FIG. 4A, it is known that when the support member CKA rotates by an angle of θ1=α1, the actuated part CKC rotates by an angle of θ2=α1, and thus a torque T(θ2=α1) is applied to the actuated part CKC. Further, when the support member CKA rotates by an angle of θ1=α1+α2, the actuated part CKC rotates by an angle of θ2=α1+α2, i.e., the torque applied to the actuated part CKC is T(θ2=α1+α2). In other words, if the support member CKA rotates by the total angle of θ1=α1+α2, a total torque T(θ2=α1+α2) is applied to the actuated part CKC.

FIGS. 2A to 2B and 4B illustrate the relationship between the rotation angle (θ1) of the support member SP2 and the torque T (θ2) applied to the actuated portion POC according to the aforementioned equation (1). As shown in FIG. 4B, it is known that when the support member SP2 rotates by an angle of θ1=α1, the actuated part POC rotates by an angle of θ2=β1 which is less than α1, i.e., the torque applied to the actuated part POC is T(θ2=β1). Further, when the support member SP2 rotates by a total angle θ1=α1+α2, the actuated part POC rotates by an angle of θ2=β1+β2 that is less than α1+α2, i.e., the torque applied to the actuated part POC is T(θ2=β1+β2). In other words, if the support member SP2 rotates by the total angle of α1+α2, a torque T(θ2=β1+β2) less than the torque T(θ2=α1+α2) will be applied to the actuated part POC. As a result, because the user wearing the knee joint auxiliary device applies a smaller torque T(θ2=β1+β2) to the actuated part POC, the output of the thigh muscle force of the user can be reduced.

FIGS. 1A-1, 1C-1, 1C-2, and 5 illustrate the knee joint auxiliary device DE that can be in various positioning states. In detail, in order to adapt the knee joint auxiliary device DE having the symmetrical axis SAX, the power providing mechanism PP, and the power providing mechanism pp to the relative positions among the thigh part T, the knee part K, and the shank part S of the user, the user may configure the knee joint auxiliary device DE to be in a first positioning state as desired. In the first positioning state: the thigh adjustment element end SP1G of each of the set of thigh adjustment elements SP1C is engaged into a corresponding thigh adjustment hole of the first thigh adjustment part TSB1 of the set of thigh adjustment parts TSB of through a corresponding thigh installation hole of the set of thigh installation holes SP1D, each of the end PN2B, the end PN3B, and the end PN5B is engaged into a corresponding near-knee adjustment hole of the first near-knee adjustment part SSE1 of the set of near-knee adjustment parts SSE, and the shank adjustment element end SP2N of each of the set of shank adjustment elements SP2I is engaged into the corresponding shank adjustment hole of the first shank adjustment part SSD1 of the set of shank adjustment parts SSD via the shank installation hole SP2H.

Alternatively, in order to adapt to the relative positions among the thigh part T, the knee part K, and the shank part S of, the knee joint auxiliary device DE can be configured to be in a second positioning state. In the second positioning state: the thigh adjustment element end SP1G of each of the set of thigh adjustment elements SP1C is engaged into a corresponding thigh adjustment hole of the second thigh adjustment part TSB2 of the set of thigh adjustment parts TSB of through a corresponding thigh installation hole of the set of thigh installation holes SP1D, each of the end PN2B, the end PN3B, and the end PN5B is engaged into a corresponding near-knee adjustment hole of the second near-knee adjustment part SSE2 of the set of near-knee adjustment parts SSE, and the shank adjustment element end SP2N of each of the set of shank adjustment elements SP2I is engaged into the corresponding shank adjustment hole of the second shank adjustment part SSD2 of the set of shank adjustment parts SSD via the shank installation hole SP2H.

Alternatively, in order to adapt to the relative positions among the thigh part T, the knee part K, and the shank part S, the knee joint auxiliary device DE can be configured to be in a third positioning state. In the third positioning state: the thigh adjustment element end SP1G of each of the set of thigh adjustment elements SP1C is engaged into a corresponding thigh adjustment hole of the third thigh adjustment part TSB3 of the set of thigh adjustment parts TSB of through a corresponding thigh installation hole of the set of thigh installation holes SP1D, each of the end PN2B, the end PN3B, and the end PN5B is engaged into a corresponding near-knee adjustment hole of the third near-knee adjustment part SSE3 of the set of near-knee adjustment parts SSE, and the shank adjustment element end SP2N of each of the set of shank adjustment elements SP2I is engaged into the corresponding shank adjustment hole of the third shank adjustment part SSD3 of the set of shank adjustment parts SSD via the shank installation hole SP2H.

Further, in each of the first ˜ third positioning states, the thigh adjustment element end SP1G is secured to the thigh support side TSA after being screwed into a first corresponding nut, each of the end PN2B, the end PN3B, and the end PN5B will be secured to the shank support side SSA after being screwed into a second corresponding nut, and the shank adjustment element end SP2N will be secured to the shank support side SSB after being screwed into a third corresponding nut. Each of the first, second, and third corresponding nuts can be identical to the nut NU.

In addition, the power providing mechanism pp has an end sp1b, a support member sp2, a link li1, a link li2, a power source po (comprising a power transmission component poa having an actuated part poc), a protection structure pr, a link li3, and an end sp1a corresponding to the end portion SP1B, the second support member SP2, the link LI1, the link LI2, the power source PO, the protection structure PR, the link LI3, and the end SP1A, respectively. The device DE has a connection block sp1e formed between the end sp1a and the end sp1b, and the end sp1a, the connection block sp1e, and the end sp1b form the support member sp1.

Further, the end SP1A and the thigh support side TSA form a first upper structure, and the end SP1B, the support member SP2, the link LI1, the link LI2, the power source PO, the protection structure PR, the link LI3, the shank support side SSA, and the shank support side SSB form a first lower structure.

On the other hand, the end sp1a and the thigh support side tsa form a second upper structure, and the end sp1b, the support member sp2, the link li1, the link li2, the power source po, the protection structure pr, the link li3, the shank support side ssa, and the shank support side ssb form a second lower structure. In each of the first ˜ third positioning states, the first upper structure and the first lower structure are structurally symmetrical with the second upper structure and the second lower structure with respect to the symmetrical axis SAX, respectively.

In addition, the connection block SP1E is designed to be bent toward the thigh support side TSA so that there is a first bending angle between the end SP1A and the connection block SP1E to match the contour formed of the first knee part side KL and the first thigh side TL, and the connection block sp1e is designed to be bent toward the thigh support side tsa so that there is a second bending angle formed between the end sp1a and the connection block sp1e to match the contour formed of the second knee part side KR and the second thigh side TR.

Further, when the knee joint auxiliary device DE is worn on the lower limb L of the user, the thigh support side TSA is provided to be located at the first thigh side TL, the first shank support side SSA and the second shank support side SSB mutually adjacent to each other are provided to be located at the first shank side SL such that the end SP1B is located at the first knee part side KL, the second thigh support side tsa is provided to be located at the second thigh side TR, and the third shank support side ssa and that fourth shank support side ssb are provided to be located at that second shank side SR such that that end sp1b is located at that second knee part side KR, and: when the lower limb L is the left leg, a thickness of the connection block SP1E is designed to be greater than a thickness of the connection block sp1e to improve the anti-collision capability of the connection block SP1E, and the second bending angle is preferably greater than the first bending angle, wherein the knee joint auxiliary device DE can be a first knee joint assistive device, a second knee joint auxiliary device configured such that the power providing mechanism PP is removed, or a third knee joint auxiliary device configured such that the power providing mechanism pp is removed; and when the lower limb is the right leg, the thickness of the connection block sp1e is designed to be greater than the thickness of the connection block SP1E to improve the anti-collision capability of the connection block sp1e, and the second bending angle is preferably smaller than the first bending angle, wherein the knee joint auxiliary device DE can be a fourth knee joint auxiliary device, a fifth knee joint auxiliary device configured such that the power providing mechanism PP is removed, or a sixth knee joint auxiliary device configured such that the power providing mechanism pp is removed.

In addition, for being assisted in entering the transition state from the upright state, the flexion state from the transition state, the transition state from the flexion state, and the upright state from the transition state according to the needs of the user during the process of stepping up or down stairs or walking, the user can: wear the first knee joint auxiliary device on the left leg, and wear one of the fourth knee joint auxiliary device, the fifth knee joint auxiliary device, and the sixth knee joint auxiliary device on the right leg; wear the second knee joint auxiliary device on the left leg, and wear one of the fourth knee joint auxiliary device, the fifth knee joint auxiliary device, and the sixth knee joint auxiliary device on the right leg; wear the third knee joint auxiliary device on the left leg, and wear one of the fourth knee joint auxiliary device, the fifth knee joint auxiliary device, and the sixth knee joint auxiliary device on the right leg; wear one of the first knee joint auxiliary device, the second knee joint auxiliary device, and the third knee joint auxiliary device on the left leg, and wear no knee joint auxiliary device on the right leg; or wear one of the fourth knee joint auxiliary device, fifth knee joint auxiliary device, and sixth knee joint auxiliary device on the right leg, and wear no knee joint auxiliary device on the left leg.

In addition, because the first upper structure and the first lower structure are structurally symmetrical with the second upper structure and the second lower structure, respectively, with respect to the symmetrical axis SAX, similar to the descriptions of the support member SP2 and the actuated part POC of the power providing mechanism PP in the paragraphs directed to FIGS. 2A to 2D: when entering the transition state from the upright state, the actuated part poc also rotates by an angle of β1 which is smaller than the angle of α1 by which the support member sp2 rotates; when entering the flexion state from the transition state, the actuated part poc rotates by an angle of β2 which is smaller than the angle of α2 by which the support member sp2 rotates; when entering the transition state from the flexion state, the actuated part poc will also rotate by an angle of β2 which is smaller than the angle of α2 by which the support member sp2; and when entering the upright state from the flexion state, the actuated part poc also rotates by an angle of β1 which is smaller than the angle of α1 by which the support member sp2 rotates.

In addition, due to the structural symmetry, similar to the descriptions of the power providing mechanism PP in the paragraphs directed to FIG. 4B, the user outputs the same smaller torque T(θ2=β1+β2) to the actuated part poc if the spring body (not shown) of the power source PO has the same spring coefficient as the spring body POG of the power source PO.

Depending on the actual requirements of the user, the spring body of the power source po and the spring body POG of the power source PO can have different spring coefficients. For the general user who needs to wear the knee joint auxiliary device, the spring coefficient of each of the spring body of the power source po and the spring body POG of the power source PO can be in the range from 65 to 85 N·mm/degree.

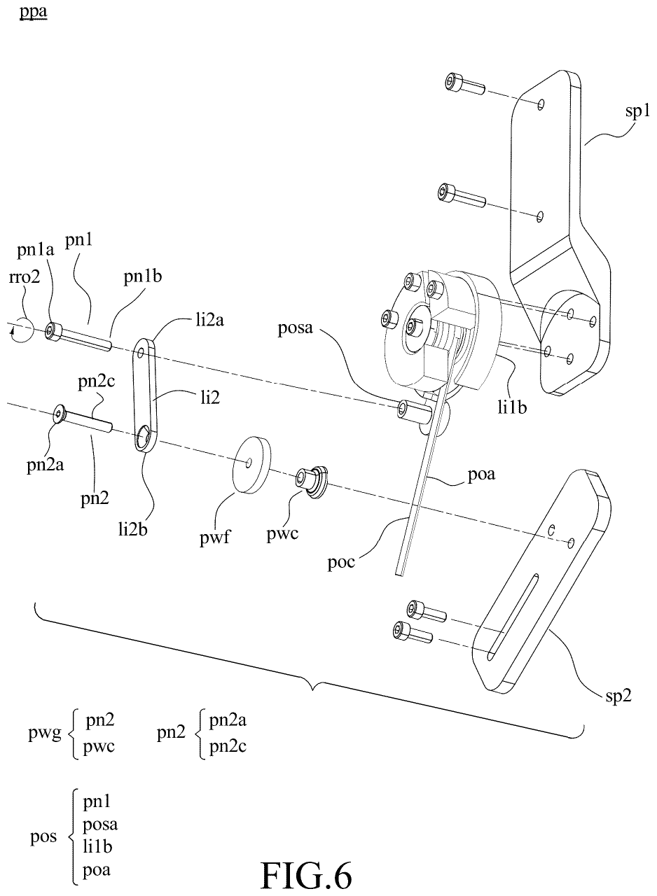

FIG. 6 illustrates a power providing mechanism ppa for a knee joint auxiliary device of the present invention. The power providing mechanism ppa includes a support member sp1, a support member sp2, a power transmission structure pwg, a power source assembly pos, and a link li2.

The power transmission structure pwg has a power body pwc, a baffle part pwf, and an installation pin pn2, and the installation pin pn2 has an end pn2a and an installation part pn2c. The power source assembly pos has (or is built with) a hinge pin pn1, an end posa, a side portion li1b, and a power transmission component poa, wherein the power transmission component poa has an actuated part poc, and the hinge pin pn1 has an end pn1a, and an end pn1b. The link li2 has an end li2a and an end li2b opposite to each other.

Furthermore, the end pn1b is configured to pass through the end li2a and the end posa in sequence to hinge the end pn1a with the end li2a and to combine the end li2a with the end posa, and the side part li1b is installed on the support member sp1.

In addition, the installation part pn2c is configured to pass through the end li2b, the baffle part pwf, and the power body pwc in a sequence to be installed into the support member sp2, so as to rotatably dispose the end pn2a on the end li2b and combine the end li2b, the baffle part pwf, the power body pwc, and the support member sp2 together. The power transmission component poa has an appropriate length such that the actuated part poc can be actuated by the power body pwc.

Accordingly, the support member sp2 can rotate in the rotation direction rro2 by means of the link li2 with respect to the end pn1a, so that the power body pwc can actuate the actuated part poc for allowing the power transmission component poa to rotate to store the corresponding power in the power source assembly pos. The support member sp2 can also rotate by means of the hinge pin pn2 when rotating by means of the link li2 with respect to the hinge pin pn1, so that during the period of entering the transition state from the upright state, entering the flexion state from the transition state, entering the transition state from the flexion state, or entering the upright state from the transition state, the support member sp2 will rotate by a total angle greater than the angle by which the power transmission component poa rotates.

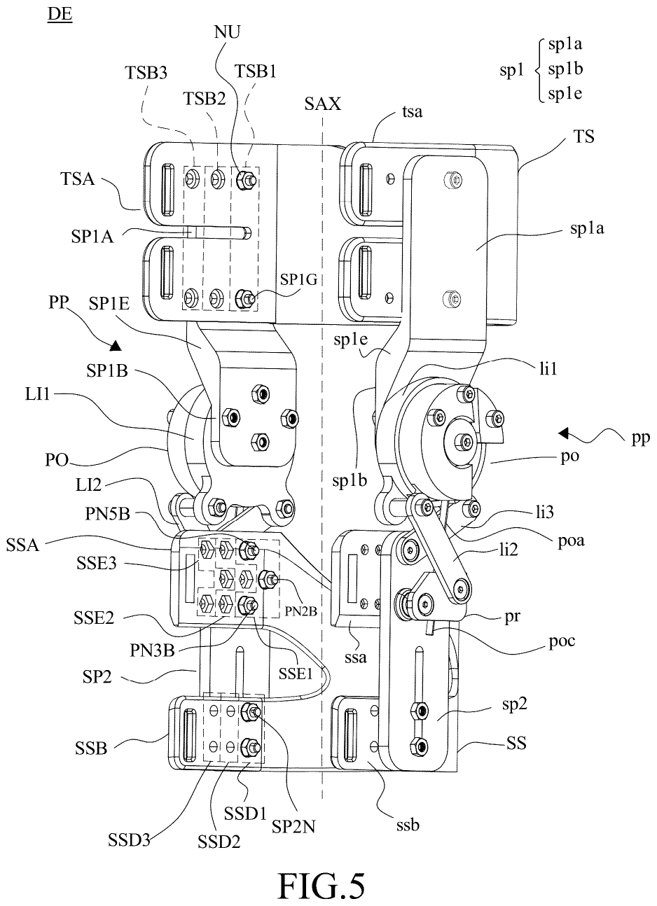

Additionally, the baffle part pwf can protect the actuated part poc from undesired external interferences. Moreover, depending on the actual usage requirements, the power providing mechanism pp of the knee joint auxiliary device DE in FIG. 5 can be designed to adopt the structure of the power providing mechanism ppa.

Based on an alternative embodiment according to FIG. 6, the power providing mechanism ppa can have a power source assembly pos that comprises: a power transmission structure pwg having an end pn2a and an installation part pn2c; an end posa and a support member sp1 which are integrally formed with the power source assembly pos; a second support member sp2 in which the installation part pn2c is installed; and a link li2 having an end li2a and an end li2b mutually opposite to each other, wherein the end li2a is combined with the end posa, and the end pn2a is rotatably disposed on the end li2b.

Furthermore, the appropriate design dimensions for each element of the power providing mechanism PP, the power providing mechanism pp, and the power providing mechanism ppa can be obtained using the linkage motion simulation software such as ADAMS, SAM, Linkage, and the like. Taking the power providing mechanism PP as an example, the distance between any two of the end PN1A, end PN2A, end PN4A, and end PN5A, the length and width of each link, the length and width of each supporting member, and so on can be obtained by using the mentioned linkage motion simulation software in accordance with the respective actual limb dimensions and needs of different users.

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A knee joint auxiliary device having a power source, comprising:
a first support member, having a first end;
a second support member;
a first link having a first side part, a second side part, and a second end;
a second link having a third end and an opposite fourth end;
the power source having a first power transmission component and a fulcrum; and
a second power transmission component having an installation part, a fifth end, and a power body arranged between the installation part and the fifth end, wherein:
the second side part is installed on the first end, the power source is installed on the first side part, the installation part is installed into the second support member, the fifth end is disposed on the fourth end of the second link, and the third end is hinged with the second end so that the second support member is capable of rotating by a first angle relative to the second end through the second link to cause the power body to actuate the first power transmission component to rotate by a second angle relative to the fulcrum for storing a power in the power source, wherein the first angle is larger than the second angle.

2. The knee joint auxiliary device as claimed in claim 1, wherein:
the knee joint auxiliary device is to be worn on a lower limb of one of a left leg and a right leg of a user, and the lower limb has a thigh part and a shank part;
the knee joint auxiliary device further includes a thigh support and a shank support, the thigh support has a first receiving part and a thigh support side, and the shank support has a second receiving part, a first shank support side and a second shank support side adjacent to the first shank support side;
the thigh support side is configured to form the first receiving part for receiving the thigh part, and the first shank support side and the second shank support side are configured to form the second receiving part for receiving the shank part; and
at least one of the thigh support and the shank support is made of a thermoplastic material.

3. The knee joint auxiliary device as claimed in claim 2, wherein:
the thermoplastic material is a thermoplastic polyurethane;
the first link further includes a sixth end, an opposite seventh end, a bearing, a first hinge pin, a second hinge pin, a slit, and a link body between the first side part and the second side part, wherein the first hinge pin includes the second end and an eighth end opposite to the second end, the second hinge pin includes a ninth end and an opposite tenth end, the sixth end and the seventh end has a first hole and a second hole respectively, and the slit is arranged between the sixth end and the seventh end;
the third end and the fourth end of the second link have a third hole and a fourth hole, respectively; and
the second support member further has an eleventh end and a third hinge pin, the eleventh end has a first block area and a second block area mutually adjacent to each other, and the second block area has a first area section and a second area section mutually adjacent to each other, wherein the first block area has a fifth hole, the first area section and the second area section have a sixth hole and a seventh hole respectively, and the third hinge pin has a twelfth end and an opposite thirteenth end.

4. The knee joint auxiliary device as claimed in claim 3, further comprising a protection structure, wherein:
the protection structure has the second power transmission component, a support part, a connection component, and a first installation pin;
the second power transmission component has a second installation pin, the power body has an eighth hole, the eighth hole has a central axis, the second installation pin has the fifth end and an opposite fourteenth end, and the installation part is arranged between the fifth end and the fourteenth end; and
the support part has a ninth hole, the connection component has a fifteenth end and a sixteenth end, the fifteenth end and sixteenth end have a tenth hole and an eleventh hole respectively, and the first installation pin has a seventeenth end and an eighteenth end.

5. The knee joint auxiliary device as claimed in claim 4, further comprising a third link having a nineteenth end and a twentieth end, wherein the nineteenth end and the twentieth end have an eleventh hole and a twelfth hole respectively;
the eighth end is configured to pass through the third hole, the bearing, and the first hole in sequence, so as to hinge the third end with the second end, and combine the third end, the bearing, and the sixth end together; and
the fourteenth end of the second installation pin is configured to pass through the fourth hole, the tenth hole, the eighth hole, and the fifth hole along the central axis of the power body, so as to form a combination of the fourth end, the fifteenth end, the power body and the first block area, wherein in the combination, the installation part is disposed in the fifth hole, and the fifth end of the second hinge pin is rotatably disposed on the fourth end so that the second support member is rotatable relative to the central axis of the power body by means of the fifth end of the second power transmission component.

6. The knee joint auxiliary device as claimed in claim 5, wherein:
the eighteenth end is configured to pass through the eleventh hole, the ninth hole and the sixth hole in sequence, so as to combine the sixteenth end, the support part and the second area section together, and the seventeenth end is disposed on the sixteenth end;
the tenth end is configured to pass through the eleventh hole and the second hole in sequence to hinge the ninth end with the nineteenth end and to combine the nineteenth end with the seventh end;
the thirteenth end is configured to pass through the twelfth hole and the seventh hole in sequence to hinge the twentieth end with the twelfth end and to combine the first section area with the twentieth end; and
the third link is rotatable relative to either of the ninth end and the twelfth end to maintain a stability between the second support member and the first link when the second support member is rotated relative to the second end along the central axis.

7. The knee joint auxiliary device as claimed in claim 6, wherein:
the second power transmission component, the support part, and the connection part of the protection structure form a protection space;
the power source further comprises a receiving part, a torsion spring, and a baffle, the torsion spring has a spring body, the fulcrum, and the first power transmission component, the receiving part is configured to receive the spring body, the baffle is combined with the receiving part for preventing the spring body from falling off the receiving part, and the first power transmission component has an actuated part; and
the receiving part is installed on the first side part, the actuated part is configured to be actuated by the power body to rotate the first power transmission component in the slit relative to the fulcrum, and the actuated part is provided in the protection space to prevent the actuated part from being subject to an external interference.

8. The knee joint auxiliary device as claimed in claim 7, wherein:
the first support member further has a twenty-first end opposite to the first end, the twenty-first end has a set of thigh installation holes and a set of thigh adjustment elements;
the second support member further has a twenty-second end opposite to the eleventh end, and the twenty-second end has a shank installation hole and a set of shank adjustment elements; and
the thigh support side has a set of thigh adjustment portions, the first shank support side has a set of near-knee adjustment parts, and the second shank support side has a set of shank adjustment parts.

9. The knee joint auxiliary device as claimed in claim 8, wherein:
the knee joint auxiliary device is configured to be in one selected from a first positioning state, a second positioning state, and a third positioning state while being worn on the lower limb of the user;
in the first positioning state, a thigh adjustment element end of each of the set of thigh adjustment elements is engaged into a corresponding thigh adjustment hole of a first thigh adjustment part of the set of thigh adjustment parts through a corresponding thigh installation hole of the set of thigh installation holes, each of the fourteenth end, the eighteenth end and the thirteenth end portion is engaged into a corresponding near-knee adjustment hole of a first near-knee adjustment part of the set of near-knee adjustment parts, and a shank adjustment element end of each shank adjustment element of the set of shank adjustment elements is engaged into a corresponding shank adjustment hole of a first shank adjustment part of the set of shank adjustment parts through the shank installation hole;
in the second positioning state, the thigh adjustment element end of each thigh adjustment element of the set of thigh adjustment elements is engaged into a corresponding thigh adjustment hole of a second thigh adjustment part of the set of thigh adjustment parts through the corresponding thigh installation hole of the set of thigh installation holes, each of the fourteenth end, the eighteenth end and the thirteenth end is engaged into a corresponding near-knee adjustment hole of a second near-knee adjustment part of the set of near-knee adjustment parts, and the shank adjustment element end of each shank adjustment element of the set of shank adjustment elements is engaged into a corresponding shank adjustment hole of a second shank adjustment part of the set of shank adjustment parts through the shank installation hole;
in the third positioning state, the thigh adjusting element end of each of the set of the thigh adjustment elements is engaged into a corresponding thigh adjustment hole of a third thigh adjustment part of the set of thigh adjustment parts through the corresponding thigh installation hole of the set of thigh installation holes, each of the fourteenth end, the eighteenth end and the thirteenth end is engaged into a corresponding near-knee adjustment hole of a third near-knee adjustment part of the set of near-knee adjustment parts, and the shank adjustment element end of each shank adjustment element of the set of shank adjustment elements is engaged into a corresponding shank adjustment hole of a third shank adjustment part of the set of shank adjustment parts through the shank installation hole; and
in each of the first to the third positioning states, the thigh adjustment element end is screwed into a first corresponding nut to be secured to the thigh support side, each of the fourteenth end, the eighteenth end and the thirteenth end is screwed into a second corresponding nut to be secured to the first shank support side, and the shank adjustment element end is screwed into a third corresponding nut to be secured to the second shank support side.

10. The knee joint auxiliary device as claimed in claim 9, wherein:
the bearing, the power body and the second link form an accommodation space, and the accommodation space is configured to accommodate the twentieth end such that a longitudinal axis of the third link is configured to be in a cross shape with a longitudinal axis of the second link.

11. The knee joint auxiliary device as claimed in claim 10, wherein:
the thigh support side is a first thigh support side, and the thigh support has a second thigh support side opposite to the first thigh support side, the first thigh support side and the second thigh support side form the first receiving part; and
the shank support has a third shank support side and a fourth shank support side mutually adjacent to each other and opposite to the first shank support side and the second shank support side respectively, wherein the first shank support side, the second shank support side, the third shank support side and the fourth shank support side form the second receiving part.

12. The knee joint auxiliary device as claimed in claim 11, wherein:
the protection structure is a first protection structure, and the knee joint auxiliary device further has a twenty-third end, a third support member, a fourth link, a fifth link, a second power source, a second protection structure, a sixth link and a twenty-fourth end corresponding to the first end, the second support member, the first link, the second link, the power source, the first protection structure, the third link and the twenty-first end respectively; the twenty-first end and the first thigh support side form a first upper structure, and the first end, the second support member, the first link, the second link, the power source, the first protection structure, the third link, the first shank support side and the second shank support side form a first lower structure; and
the twenty-fourth end and the second thigh support side form a second upper structure, and the twenty-third end, the third support member, the fourth link, the fifth link, the second power source, the second protection structure, the sixth link, the third shank support side, and the fourth shank support side form a second lower structure.

13. The knee joint auxiliary device as claimed in claim 12, further comprising a symmetrical axis and a fourth support member, wherein:
in each of the first to third positioning states, the first upper structure and the first lower structure are structurally symmetric with the second upper structure and the second lower structure respectively with reference to the symmetrical axis;
the first support member further has a first connection block connected between the first end and the twenty-first end; and
the fourth support member has a twenty-third end, a twenty-fourth end, and a second connection block connected between the twenty-third end and the twenty-fourth end.

14. The knee joint auxiliary device as claimed in claim 13, wherein:
the lower limb has a knee part between the thigh part and the shank part, the thigh part has a first thigh side and a second thigh side opposite to the first thigh side, the shank part has a first shank side and a second shank side opposite to the first shank side, and the knee part has a first knee part side located between the first thigh side and the first shank side and a second knee part side opposite to the first knee part side and located between the second thigh side and the second shank side.

15. The knee joint auxiliary device as claimed in claim 14, wherein when the knee joint auxiliary device is worn on the lower limb of the user:
the thigh support side is located on the first thigh side, and the first shank support side and the second shank support side are located on the first shank side so that the first end is located on the first knee part side; and
the second thigh support side is located on the second thigh side, and the third shank support side and the fourth shank support side are located on the second shank side so that the twenty-third end is located on the second knee part side.

16. The knee joint auxiliary device as claimed in claim 15, wherein when the lower limb is the left leg:
a thickness of the second connection block is designed to be smaller than a thickness of the first connection block;
the first connection block is designed to be bent toward the first thigh support side so that there is a first bending angle between the first connection block and the twenty-first end to match a contour formed of the first knee part side and the first thigh side, and the second connection block is designed to be bent toward the second thigh support so that there is a second bending angle formed between the twenty-fourth end and the second connection block to match a contour formed of the second knee part side and the second thigh side, wherein the second bending angle is greater than the first bending angle; and
when the lower limb is the right leg, the thickness of the second connection block is designed to be greater than the thickness of that first connection block, and the second bending angle is smaller than the first bending angle.

17. A mechanism having a power source assembly, comprising:
a first support member;
a second support member;
a power transmission structure having a first end and an installation part, wherein the installation part is installed in the second support member;
a second end and a side part built with the power source assembly, wherein the side part is installed on the first support member; and
a link having a third end and a fourth end mutually opposite to each other, wherein the third end is combined with the second end, and the first end is rotatably disposed on the fourth end.

18. The mechanism as claimed in claim 17, wherein:
the power source assembly further has a hinge pin and an actuated part, the hinge pin has a fifth end and a sixth end, and the sixth end is configured to pass through the third end and the second end in sequence to hinge the fifth end with the third end and combine the third end with the second end.

19. The mechanism as claimed in claim 18, wherein:
the power transmission structure has a power body, a baffle part and an installation pin having the first end and the installation part, the installation part is configured to pass through the fourth end, the baffle part and the power body in sequence to be installed into the second support member so as to rotatably dispose the first end on the fourth end, and to combine the fourth end, the baffle part, the power body and the second support member together, wherein the power body is configured to actuate the actuated part, and the baffle part is configured to protect the actuated part from an external interference; and
the mechanism is configured to be applied to a knee joint auxiliary device.

20. A mechanism having a power source assembly, comprising:
a power transmission structure having a first end and an installation part;
a second end and a first support member which are integrally formed with the power source assembly;
a second support member in which the installation part is installed; and
a link having a third end and a fourth end mutually opposite to each other, wherein the third end is combined with the second end, and the first end is rotatably disposed on the fourth end.
